(19) United States
(12) Patent Application Publication
(10) Pub. No.: US 2011/0305806 A1
(43) Pub. Date: Dec. 15, 2011

(54) Process for producing boneless poultry wings

(76) Inventor: Michael Ventimiglia, Jupiter, FL (US)

(21) Appl. No.: 13/156,932

(22) Filed: Jun. 9, 2011

Related U.S. Application Data
(60) Provisional application No. 61/353,131, filed on Jun. 9, 2010.

(51) Int. Cl. A23L 1/315; A23P 1/00; A23B 4/06

(52) U.S. Cl. 426/393; 426/480

(57) ABSTRACT

The present invention is directed toward a method of making a food product from the mid-joint wing portion of a three joint bird wing. After the wing tip and drumette are removed from the mid-joint wing portion, the mid-joint wing portion is cooked. The cooking of the mid-joint wing section reduces the degree of force needed to remove the flesh from the bones as well as causing the meat surrounding the ulna and radius bones to shrink, such that end portions of the two bones are exposed, thereby further facilitating their removal. The food product that results from this process is a cooked, boneless mid-joint wing portion. The process is taught as a progression of steps which may be performed manually or as an automated process.

### CROSS-REFERENCE TO RELATED APPLICATIONS

This application claims the benefit of U.S. Provisional Application No. 61/353,131, filed on Jun. 9, 2010, the contents of which are herein incorporated by reference.

### FIELD OF THE INVENTION

This invention relates to food preparation; particularly to both a manual and automated process designed to produce a cooked, boneless chicken wing food product; and most particularly to a process for producing a boneless cooked mid-joint wing section from which the ulna and radius bones have been removed, the food product produced thereby.

### BACKGROUND OF THE INVENTION

Poultry, fowl, and the like are generally eviscerated, dressed, and sold as a whole bird or severed into selected parts, i.e., breast, thighs, wings, etc. One of the parts which is sometimes separated and sold is the bird's three joint wing, which comprises a drumette, a mid-joint wing section, and a wing tip section, which is attached to one end of the mid-joint section. Typically, bird wings have not been as commercially valuable as other parts of birds, such as breasts, thighs, and legs, in part due to the relatively small amount of meat in the wing, the high percentage of skin, bone and joints to meat, and the relative difficulty of removal of such bones, so as to derive a truly boneless wing.

There has been an ever increasing demand for meat products which require less time for preparation, which include little or no waste, and which are boneless or relatively boneless, making such products easier to consume. For these reasons, products such as boneless chicken breast, chicken tenders, etc., have enjoyed tremendous commercial success.

Bird wings have not been particularly amenable to such enhanced commercial processing and/or preparation methods for a variety of reasons primarily related to the relatively small amount of meat, the size and centralized location of the bones, etc. Prior art attempts to produce chicken wing products which are more attractive to the consumer have failed to produce a truly boneless wing, and instead have gone in the direction of utilizing boneless breast meat, but nevertheless advertising these products as “boneless chicken wings”. Some prior art disclosures even went so far as to cook the wings in an effort to shrink the meat, thereby exposing the bones for use as “handles” to enhance their popularity as finger food, but failed to teach or suggest a truly boneless chicken wing product.

Although numerous devices and food products have been shown in the prior art, these efforts have failed to produce a cooked boneless wing portion as a commercially viable product. If such a process and food product could be successfully produced and commercialized, a long felt need in the art will be satisfied.

### PRIOR ART

U.S. Pat. No. 4,041,572 to Martin, et al. is directed toward a de-boning machine having a plurality of similar operational heads respectively designed to receive and mechanically engage a centrally-extending elongated meat-encased bone member characterized by having a single shaft and at the respective longitudinal ends thereof a ball or a socket structure comprising part of a ball-and-socket joint, exemplary of which would be the bone in a chicken thigh or the like, and thereafter by a sequential camming activation of cutting and peeling blades of the respective operational heads, while the heads are being operationally driven, automatically effect an annular severing of the encasing meat about the elongated bone shaft at that end thereof immediately interior of the socket structure, and then initiate a longitudinal removal of the encasing meat from the bone shaft by inversely peeling the encasing meat upon itself along the bone shaft length, then moving the peeled meat around the ball structure at the opposite end of the elongated bone shaft, after which the meat retaining tendons are severed and a complete removal of the meat from the bone is accomplished. Martin, et al. fails to teach or suggest a process for producing a boneless cooked mid-joint wing section from which the ulna and radius bones have been removed in accordance with the instantly disclosed invention, nor the food product produced thereby.

U.S. Pat. No. 4,648,155 to Burnett illustrates a method and an apparatus for removing meat and wings from an eviscerated bird wherein the wings are partially severed at the joint between the body and the wing and gripping the wings and pulling them away from the body such that the wings and connected breast meat are removed from the body. Burnett fails to teach or suggest a process for producing a boneless cooked mid-joint wing section from which the ulna and radius bones have been removed in accordance with the instantly disclosed invention, nor the food product produced thereby.

U.S. Pat. No. 4,942,642 to Fankhauser, II, et al. describes a deboning system adapted for use in separating intact the proximal and distal bones of a fowl wing and for removing the proximal bones substantially intact from the proximal portion to provide a comestible receiving cavity therewithin. The system includes a force applying disjointing unit for separating the proximal and distal bones at their connecting joint, and a deboning unit for removing the separated proximal bones from the fowl wing substantially intact to create a cavity in the deboned fowl wing. Fankhauser, II et al. fail to teach or suggest a process for producing a boneless cooked mid-joint wing section from which the ulna and radius bones have been removed in accordance with the instantly disclosed invention, nor the food product produced thereby.

U.S. Pat. No. 5,232,397 to Gagliardi, Jr. teaches a method of making a food product from the wing of a bird and the food product made in accordance with the method. The wing includes a middle section, a tip section connected to one end of the middle section, and an end section attached to the other end of the middle section. The food product is produced by cutting the bird wing in order to separate the middle section from the tip and end sections. The separated middle section is cut along a first cut line to remove the first knuckle from the separated middle section. The separated middle section is also cut along a second cut line to remove the second knuckle from the separated middle section. When the food product is cooked, the meat shrinks inwardly to expose end portions of bones within the middle section. Gagliardi, et al. fails to teach or suggest a process for producing a boneless cooked mid-joint wing section from which the ulna and radius bones have been removed in accordance with the instantly disclosed invention, nor the food product produced thereby.

U.S. Pat. No. 5,368,519 to Curtis, et al. describes a method of making a food product from a bird wing and the food product made in accordance with the method. A method of making a food product from a wing of a bird is described wherein the middle section (or mid-joint wing section) having a tip section attached to one end and a drumette section attached to the other end is cut in order to separate the middle section from the drumette section. The middle section is then cut along a line extending generally parallel to the middle section axis and spaced from the joint shared by the middle section and the drumette by a predetermined distance to remove the joint from the middle section. The tip section is then bent with respect to the middle section to expose at least a portion of both of the middle section bones proximate to the joint of the middle section and the tip section. A score line may be used to facilitate exposure of the two bones. The exposed portions of both of the middle section bones are then pulled to remove the two bones from the middle section to thereby provide a food product comprising a boneless middle section attached to the tip section, the tip section functioning as a convenient handle. Curtis, et al. fails to teach or suggest a process for producing a boneless cooked mid-joint wing section from which the ulna and radius bones have been removed in accordance with the instantly disclosed invention, nor the food product produced thereby.

U.S. Pat. No. 5,494,479 to Lindert, et al. provides an apparatus for deboning animal extremities, such as poultry wings. The apparatus comprises means for transporting the extremity; means for cutting the bones of said extremity in a direction transverse to their longitudinal axes; and means for removing bones from said extremity in the direction of said axes. The bones may be separated from the meat by retaining the meat while pulling or pushing the cut bones therefrom. For deboning poultry wings, the apparatus preferably comprises two cutting discs or blades that cut the wing on either side of the joint to allow the joint to be disposed and the remainder deboned by removing the bones therefrom. Lindert, et al. fails to teach or suggest a process for producing a boneless cooked mid-joint wing section from which the ulna and radius bones have been removed in accordance with the instantly disclosed invention, nor the food product produced thereby.

U.S. Pat. No. 6,042,468 to Lucero, et al. teaches a device for stabilizing a poultry breast for deboning thereof. The device comprising a mandrel adapted to conform to the shape of the underside of a poultry breast. The device further comprises two prongs mounted on the mandrel which are adapted to engage a V joint between a severed wing bone and a breast bone of a poultry breast. Lucero, et al. to teach or suggest a process for producing a boneless cooked mid-joint wing section from which the ulna and radius bones have been removed in accordance with the instantly disclosed invention, nor the food product produced thereby.

### SUMMARY OF THE INVENTION

The present invention is directed toward a method of making a unique food product from the mid joint wing portion of a bird wing. After the wing tip and the drumette are removed from the mid-joint wing portion, the mid-joint wing portion is cooked. The cooking of the middle section reduces the degree of force needed to remove the flesh from the bones as well as causing the meat surrounding the ulna and radius bones to shrink, such that end portions of the two bones are exposed. The food product that results from this process is a boneless, elongated strip of wing. The process is taught as a progression of steps which may be performed manually, or as an automated process.

Accordingly, it is a primary objective of the instant invention to teach a process for creating a cooked, boneless chicken wing, and the food product resultant from the process.

It is a further objective of the invention to teach a manual process for cooking and deboning of chicken wings to result in a true boneless chicken wing.

It is yet an additional objective to provide an automated process for deboning and cooking chicken wings, so as to result in a food product consisting of a true boneless chicken wing.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 shows a typical bird wing and illustrates proposed separation points for the wing tip section and the drumette section;

FIG. 2 shows an illustrative manual processing facility;

FIG. 3 shows an illustrative automated processing facility.

### DETAILED DESCRIPTION OF THE INVENTION

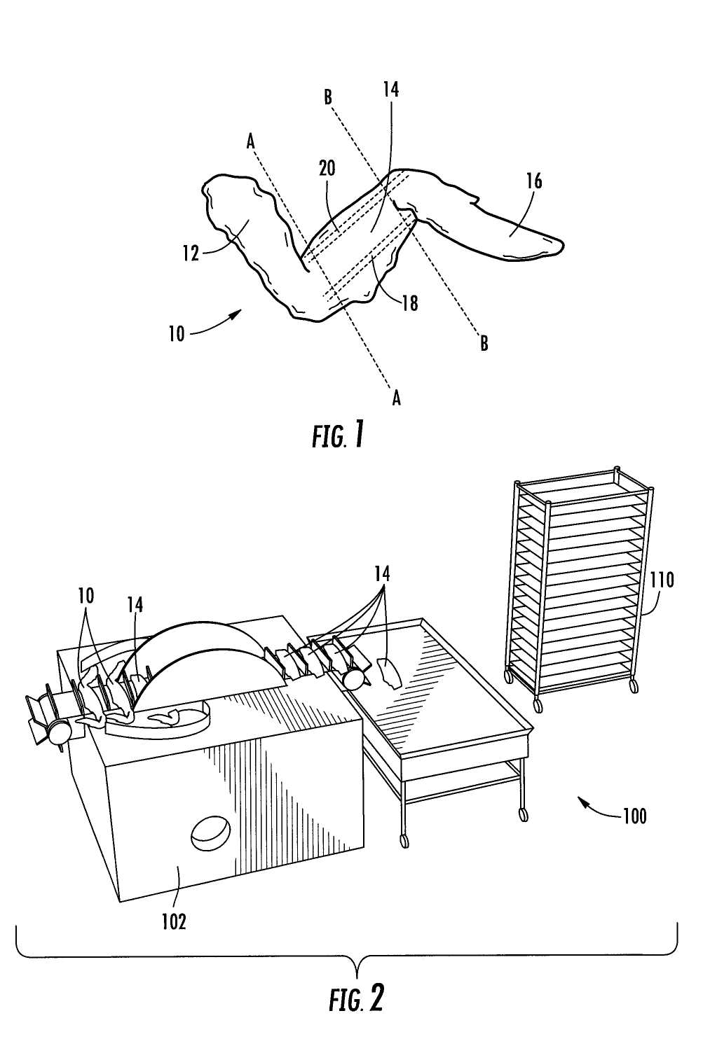

With reference to FIG. 1, an illustrative diagram of a chicken wing 10 is shown which denotes the drumette portion 12, the mid-joint portion 14 and the wing tip 16.

In the practice of this invention, whether in a manual or an automated environment, the mid-joint wing 14 will be separated from the wing tip 16 and drumette 12 by severing essentially in the regions denoted by lines A-A and B-B. The ulna bone 18 and radius bone 20 are illustrated, each of which are elongated bones whose length delineates a centrally located longitudinal axis.

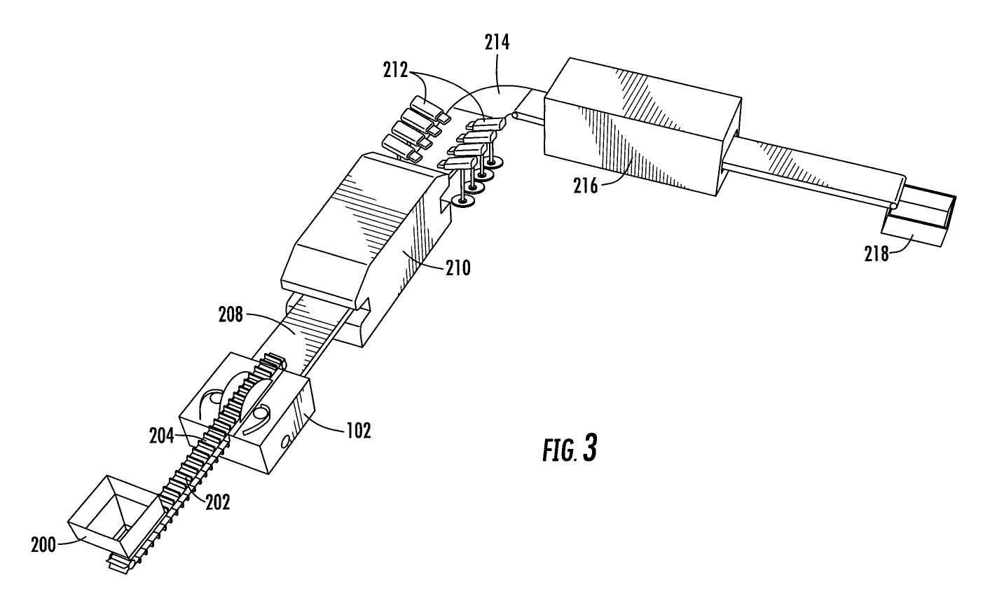

With reference to FIG. 2, a manual process is shown wherein the process is conducted in a refrigerated room 100, wherein wings 10 are placed in cutting saw machine 102, cut and then placed on rack(s) 110. Mid-joint wings 14 are brought into a cooking room (not shown) where they are placed into an oven at 350° Fahrenheit for about 26 minutes. The mid-joint wing portions 14 are subsequently removed and cooled for about 10 minutes. At this point the mid-joint wing portions 14 are sufficiently treated by heat so as to enhance bone removal. The radius 20 and ulna bones 18 are engaged with a tool such as a plier or the like (not shown), and the bones 18, 20 are manipulated by first pushing them along their longitudinal axis for about one half inch, and subsequently rotating about said longitudinal access 360°, after which the bones 18 and 20 may be removed.

Now referring to FIG. 3, an automated processing facility is illustrated. The wings 10 are fed through an input hopper 200 onto a cutting conveyor 202 which leads them to the input chute 204 of a cutting saw 102, wherein the mid-joint wing 14 will be separated from the wing tip 16 and drumette 12. The separated mid-joint wing portion 14 then travels along conveyor 208 to tunnel oven 210 where the mid-joint wing portions 14 traverse the oven 210 at a speed and temperature selected to result in a fully cooked product at the oven's exit. The mid-joint wing portions 14 are then held in a tray (not shown) which assists them in traversing the bone extractor 212, which serves to clamp and remove the radius 20 and ulna 18 bones therefrom. The tray is then flipped and the boneless mid-joint wing portions 14 continue along conveyor 214, and traverse blast freezer 216. Upon exiting the blast freezer 216, the now cooked, deboned and frozen mid-joint wing portions 14 are conveyed to boxes for frozen storage.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A process for producing a boneless chicken wing food product comprising:
providing an uncooked three joint chicken wing;
separating said three joint chicken wing into a drumette, a mid-joint wing section and a wing tip section;
processing the mid-joint section by application of heat sufficient to cause shrinkage of the flesh to thereby expose the ulna and radius bones; and
applying a series of longitudinal and rotational movements to facilitate removal of said ulna and radius bones from said mid-joint wing portion;
whereby a boneless chicken wing food product is produced.

2. A process for producing a boneless chicken wing food product comprising:
providing uncooked three joint chicken wings including a wing tip, a mid-joint wing and a drumette;
placing said uncooked three joint chicken wings onto an input hopper wherein said three-joint chicken wings are guided toward and positioned upon a cutting conveyor, whereby said three joint chicken wings are directed to an input chute of a cutting saw;
traversing said cutting saw wherein the mid joint wing is separated from the wing tip and drumette;
placing the separated mid-joint wing portion upon a second conveyor for traversal of said mid-joint wing portion through a tunnel oven at a speed and temperature selected to result in a fully cooked product wherein the ulna and radius bones are now protruding from said mid-joint wing portion to facilitate extraction thereof;
passing the mid-joint wing portions through a bone extractor wherein the radius and ulna bones are removed therefrom;
placing the boneless mid-joint wing portions upon a third conveyor which traverses a blast freezer; and
exiting the blast freezer,
whereby said cooked, deboned and frozen mid-joint wing portions are placed in containers for frozen storage.
